(19) United States
(12) Patent Application Publication
(10) Pub. No.: US 2023/0366861 A1
(43) Pub. Date: Nov. 16, 2023

(54) Packing material-containing microcolumn

(71) Applicant: ACE BioAnalysis, Inc., Fukushima (JP)

(72) Inventor: Kiyohito SHIMURA, Fukushima (JP)

(21) Appl. No.: 18/196,314

(22) Filed: May 11, 2023

(30) Foreign Application Priority Data
May 12, 2022 (JP) 2022-078757

(51) Int. Cl. G01N 30/60; G01N 30/56

(52) U.S. Cl. CPC G01N 30/606; G01N 30/6095; G01N 30/56; G01N 30/6004; G01N 2030/6008

(57) ABSTRACT

Provide is a novel microcolumn that contains a packing material and can be connected to a capillary tube. A connection structure includes a connector or a microcolumn and a plurality (e.g., two) of capillary tubes. The connecting structure is configured such that the microcolumn (or connector) and the capillary tube are in fluid communication. In one embodiment, the connection structure can be configured to be liquid-tight (to prevent liquid from flowing out from the interior of the structure to the exterior).

### BACKGROUND OF THE INVENTION

### Technical Field

This disclosure relates to microcolumns that can be used in capillary electrophoresis and high-performance liquid chromatography (HPLC).

### Background Technology

In analytical techniques using capillary tubes such as capillary electrophoresis and HPLC, capillary tubes are used for various purposes to form a series of fluid communication channels, that is, a capillary column for chromatography and capillaries for piping the system including a sample injector, a column, and valves. For example, in the case of connecting a capillary column and a capillary for piping, a chromatography fitting called a union is used. A tip of a capillary tube is fitted with a ferrule, a threaded male nut, and a sleeve that adapt the outer diameter of the capillary tube to the inner diameter of the ferrule. The assembly is inserted into a threaded female port of the central body of the union and the nut is fastened. A tip of the capillary column is connected at the other end of the union being securely connected to the capillary to establish a liquid-tight junction. In this way, a plurality of members is used to connect capillary tubes, and the connecting portion often occupies a large volume (Patent Document 1, etc.). In addition, when a plurality of members is attached to the connecting part, a certain length is required for the capillary tube to attach these members. For example, functional capillary tubes such as very short chromatography columns are difficult to connect in the first place.

### PRIOR ART DOCUMENTS

### Patent Document

[Patent Document 1] International Publication No. WO 2009/088663

### SUMMARY OF THE INVENTION

As a result of extensive research, the present inventors have developed a microcolumn that can be connected to existing capillary tubes used in capillary electrophoresis and liquid chromatography-mass spectrometry (LC-MS). In one aspect, the microcolumns of the present disclosure are connectors of capillary tubes. In one aspect, the microcolumns of the present disclosure are small-sized functional members with functionality such as separation. The present disclosure provides microcolumns and methods of making them that can be useful in analytical techniques such as capillary electrophoresis and LC-MS using capillary tubes.

Accordingly, the present disclosure provides:

### (Item 1)

A microcolumn for use in a connection structure: the said connection structure comprising the said microcolumn and two capillary tubes; the said microcolumn comprising a column tube and a packing material packed inside the said column tube and porous members disposed within the said column tube in contact with both ends of said packing material; the said microcolumn comprising openings at both ends thereof for receiving the said capillary tubes.

### (Item 2)

Any one of the preceding microcolumns, wherein the porous member comprises a porous material.

### (Item 3)

Any one of the preceding microcolumns, wherein the porous member comprises a fibrous material.

### (Item 4)

Any one of the preceding microcolumns, wherein the porous member comprises a capillary tube segment.

### (Item 5)

Any one of the preceding microcolumns, wherein the porous member comprises a porous material and a capillary tube segment, wherein the porous material being placed in contact with the packing material.

### (Item 6)

Any one of the preceding microcolumns, wherein the porous member has a length of 40% or less of the length of the microcolumn.

### (Item 7)

Any one of the preceding microcolumns, wherein the packing has a length of 5% or more of the length of the microcolumn.

### (Item 8)

Any one of the preceding microcolumns, wherein the inner diameter of the column tube is substantially the same as the outer diameter of the capillary tube.

### (Item 9)

Any one of the preceding microcolumns, wherein the packing material is a particulate packing material.

### (Item 10)

Any one of the preceding microcolumns, wherein the opening is a portion of the column tube.

### (Item 11)

Any one of the preceding microcolumns having a length of about 1-50 mm.

(Item 12)

Any one of the microcolumns described above, wherein the column tube is made of a fluororesin material.

### (Item 13)

Any one of the microcolumns described above, comprising positioning means (unit) for defining a position where the capillary tube is received in the column tube.

### (Item 14)

Any one of the microcolumns described above, wherein the positioning means defines a position such that the end of the capillary tube contacts the end of the porous member.

### (Item 15)

Any one of the microcolumns described above, wherein the column tube includes an inner column tube, the inner diameter of the column tube is substantially the same as the outer diameter of the inner column tube, and the inner column tube contains the packing material therein.

### (Item 16)

Any one of the microcolumns described above, wherein the inner column tube contains the porous member therein.

### (Item 17)

Any one of the microcolumns described above, wherein the porous member is disposed in contact with the inner column tube.

### (Item 18)

Any one of the microcolumns described above, wherein the inner column tube is composed of a glass material.

### (Item 19)

Any one of the microcolumns described above, wherein the column tube is composed of a single tube.

### (Item 20)

Any one of the microcolumns described above, wherein the column tube is composed of a plurality of tubes, and the plurality of tubes are connected via the inner column tube.

### (Item 21)

Any one of the microcolumns described above, further comprising a tubular member covering the column tube.

### (Item 22)

Any one of the microcolumns described above, wherein the column tube is composed of three tubes including a central tube and end tubes, and wherein the central tube includes the packing material.

### (Item 23)

Any one of the microcolumns described above, wherein the inner diameter of the central tube is greater than the inner diameters of the end tubes.

### (Item 24)

Any one of the microcolumns described above, wherein the tubes at both ends comprise the porous member.

### (Item 25)

Any one of the microcolumns described above, wherein the tubular member is made of a heat-shrinkable material.

### (Item 26)

Any one of the microcolumns described above, wherein the tubular member partially covers the end of the column tube.

### (Item 27)

Any one of the microcolumns described above, further comprising force-applying means (unit) for applying an external force to the tubular member, wherein the tubular member being deformed by the application of the external force by the force-applying means, thereby expanding or shrinking the space between the central tube and the tubular member.

### (Item 28)

Any one of the microcolumns described above, wherein the force-applying means comprises a pressure-control member, and the pressure-control member is arranged around a portion of the tubular member covering at least the central tube such that a pressure-regulating space is formed between the pressure-control member and the tubular member.

### (Item 29)

Any one of the microcolumns described above, wherein the pressure-control member expands the space between the central tube and the tubular member by reducing the pressure in the pressure-regulating space, and shrinks the space between the central tube and the tubular member by pressurizing the pressure-regulating space.

### (Item 30)

Any one of the microcolumns described above, wherein the central tube includes the porous member.

### (Item 31)

Any one of the microcolumns described above, wherein at least a portion of the tubular member covering the central tube is made of a flexible material.

### (Item 32)

Any one of the microcolumns described above, wherein the flexible material is a silicone material.

### (Item 33)

Any one of the microcolumns described above, wherein the outer surface of said capillary tube is coated.

### (Item 34)

A microcolumn kit comprising: any one of the microcolumns described above, said capillary tube, and positioning means for defining a position where said capillary tube is received in said microcolumn.

### (Item 35)

Any of the microcolumn kits described above, wherein the positioning means is a stopper attached to the capillary tube or an indicator put on the capillary tube.

### (Item 36)

A method for measuring a sample: including a step of connecting any one of the microcolumns described above to a capillary tube to form a connection structure, flowing a sample through the connecting structure, and measuring the sample that has passed through the connecting structure.

### (Item 37)

Any one of the methods described above, which is a method of measurement by capillary electrophoresis, LC-MS, or capillary electrophoresis-MS.

### (Item 38)

A method for manufacturing any one of the microcolumn described above, including the steps of: filling the inside of the column tube with the packing material, inserting the porous member into the column tube being in contact with the packing material.

In the present disclosure, it is contemplated that one or more of the features described above may be provided in further combinations in addition to the explicit combinations. Still further embodiments and advantages of the present disclosure will be appreciated by those skilled in the art upon reading and understanding the following detailed description, if necessary.

The present disclosure provides microcolumns to compactly connect capillary tubes, provide microscale separation systems applicable to microsamples, and/or finely control the flow of capillary tube systems. In addition, since the microcolumn of the present disclosure can be installed by inserting it in the middle of the capillary tube on the existing piping (for example, by inserting it at the breaking point of the capillary tube), it can also be used without changing the established device configuration.

### BRIEF DESCRIPTION OF THE DRAWINGS

FIG. 1A illustrates an exemplary embodiment of the microcolumn and the connecting structure of the present disclosure.

FIG. 1B illustrates an exemplary embodiment of the microcolumn and the connecting structure of the present disclosure.

FIG. 1C illustrates an exemplary embodiment of the microcolumns and the connecting structures of the present disclosure.

FIG. 2 illustrates an exemplary embodiment of the microcolumns and the connecting structures of the present disclosure.

FIG. 3 illustrates an exemplary embodiment of the microcolumns and the connecting structures of the present disclosure.

FIG. 4 is a schematic diagram of the operation of the microcolumn of FIG. 3.

FIG. 5 shows affinity chromatography of the antibody drug cetuximab using a microcolumn with protein G as an affinity ligand. The horizontal axis indicates time (minutes), and the vertical axis indicates fluorescence intensity (solid line) or electrical conductivity (dotted line).

FIG. 6A shows direct coupling of affinity chromatography and capillary isoelectric focusing for the analysis of the antibody drug cetuximab using a microcolumn with protein G as an affinity ligand in another aspect. The horizontal axis indicates time (minutes), and the vertical axis indicates fluorescence intensity (solid line) or electrical conductivity (dotted line).

FIG. 6B shows an expanded view of the part of FIG. 6A corresponding the period of the final scan with the fluorescence detector. The horizontal axis indicates time (minutes), and the vertical axis indicates fluorescence intensity (solid line) or electrical conductivity (dotted line).

### DESCRIPTION OF EMBODIMENTS

Hereinafter, the present disclosure will be described showing the best mode. Throughout this specification, it should be understood that expressions in the singular also include the concept of the plural unless specifically stated otherwise. Therefore, words with articles used in the singular (e.g., “a,” “an,” “the,” etc. in English) should be understood to include the plural of that notion, unless otherwise stated. Also, it should be understood that the terms used in this specification have the meanings commonly used in the relevant field unless otherwise specified. Thus, unless defined otherwise, all technical and scientific terms used herein have the same meaning as commonly understood by one of ordinary skill in the art to which this disclosure belongs. In case of contradiction, the present specification (including definitions) will control.

Definitions of terms and/or basic technical content particularly used in the present specification will be described below as appropriate.

### Definitions, Etc.

As used herein, the term “connection structure” refers to a portion that combines a microcolumn (or connector) and a structure (such as a capillary tube) to be connected to the microcolumn (or connector). If the connection structure occupies a small proportion of the overall structure, for example when it is incorporated in a part of the tubing of an LC system, the connection structure is a structure that exists in the range between the ends of the microcolumn (or connector).

As used herein, the term “connector” refers to a structure capable of connecting a plurality of capillary tubes (including those in a connected state).

As used herein, the term “microcolumn” refers to a tubular structure that includes at least a column tube and a packing material and has a small size (for example, a length of 5 cm or less), and is used in connection with a capillary tube to have functionality such as isolation. When an additional structure, such as a tubular member covering the microcolumn described herein, is further attached to the tubular structure, the portion including the additional structure in addition to the tubular structure is referred to as a microcolumn. In one embodiment, the inclusion of packing material inside the connector can result in a microcolumn.

As used herein, the term “column tube” refers to a cylindrical or tubular structure capable of holding a packing material therein.

As used herein, the term “packing material” refers to a substance that is retained inside a column tube and that, upon contact with the fluid passing through the inside of the column tube, affects the behavior of analytes in the fluid.

As used herein, the term “porous member” refers to a member held inside the column tube and placed in contact with the packing material. Porous members include porous materials with multiple pores (also called frits), or capillary-tube segments with a single pore (also called end pieces). The porous member may prevent loss (outflow) of the packing material and/or fix the position of the packing material.

As used herein, the term “inner column tube” refers to a cylindrical or tubular structure provided inside the column tube.

As used herein, the term “capillary tube” refers to a hollow tube having a small inner diameter (typically about 0.01 to about 1 mm). Capillary tubes used in capillary electrophoresis and HPLC are often made of fused silica or glass, but the material of the capillary tube is not particularly limited. Capillary tubes are normally liquid-tight except for their end portions. Capillary tubes are sometimes coated with polyimide or the like on the outside, and are often used with the coating attached, except in cases where it interferes with optical detection.

When describing a tubular structure herein, the term “length” is used with respect to the direction in which the hollow space extends, and with respect to the direction perpendicular to the direction in which the hollow space extends, the terms “perimeter”, “outer diameter” and “inner diameter” may be used.

As used herein, the term “kit” refers to a unit provided with parts (for example, microcolumns, capillary tubes, etc. of the present disclosure), usually provided as different parts divided into two or more components. Advantageously, the kit preferably includes manuals or instructions describing how to use or operate the parts or the like provided.

As used herein, “length” with respect to elongated members such as capillary tubes, column tubes, and pore members refers to the longitudinal size of the referenced member.

As used herein, the term “about” refers to the indicated value plus or minus 10%, unless otherwise defined. “About” when used for temperature refers to the indicated temperature plus or minus 5° C. and “about” when used for pH refers to the indicated pH plus or minus 0.5.

As used herein, the term “substantially the same” refers to a relationship in which two values are within a difference of plus or minus 10% from each other. More preferably, two values that are substantially the same fall within a range of difference within plus or minus 5% from each other.

### PREFERRED EMBODIMENT

Preferred embodiments of the present disclosure will be described below. The embodiments provided below are provided for a better understanding of the disclosure, and it is understood that the scope of the disclosure should not be limited to the following description. Therefore, it is clear that a person skilled in the art can make appropriate modifications within the scope of the present disclosure in consideration of the descriptions in this specification. It is also understood that the following embodiments of the disclosure can be used singly or in combination.

In one aspect, the present disclosure provides a connection structure comprising a connector or a microcolumn and a plurality (e.g., two) of capillary tubes. In one embodiment, the connecting structure can be configured to put the microcolumn (or connector) and the capillary tube in fluid communication. In one embodiment, the connection structure can be configured to be liquid-tight (to prevent liquid from flowing out from the interior of the structure to the exterior). In one embodiment, the connection structure of the present disclosure may perform functions other than connecting multiple capillary tubes (e.g., functions of the microcolumns described herein such as separation and flow control).

A commercially available capillary tube can be used as the capillary tube described herein, for example, it is commercially available as a tube for capillary electrophoresis or HPLC. The capillary tube has an outer diameter of, for example, about 0.05-5 mm, about 0.05 mm, about 0.1 mm, about 0.18 mm, about 0.2 mm, about 0.36 mm, about 0.5 mm, about 1 mm, about 2 mm, about 5 mm. Capillary tubes can have inner diameters of, for example, about 0.01-1 mm, about 0.01 mm, about 0.02 mm, about 0.05 mm, about 0.1 mm, about 0.2 mm, about 0.5 mm, about 1 mm, and the like. Capillary tubes can be made of, for example, fused silica or glass. The capillary tube may be coated on the outside with polyimide or the like. The performance (such as pressure resistance) of the connection structure of the present disclosure may depend not only on the physical strength of the capillary tube itself, but also on the interface interaction between the microcolumn and the capillary tube. It may be advantageous to have a suitable coating (such as polyimide) on the capillary tubes for microcolumn material (such as Teflon).

In one aspect, the present disclosure provides a microcolumn (or connector) or a combination of a microcolumn (or connector) and a capillary tube (e.g., as a kit) for use in a connecting structure. In one embodiment, a micro-column of the present disclosure comprises or consists of a connector and a column tube. In one embodiment, the microcolumn (or connector) comprises multiple openings, each receiving a separate capillary tube. The microcolumn (or connector) may accept capillary tubes with the same outer diameter or may accept capillary tubes with different outer diameters, and the size of the opening can be adjusted to the outer diameter of the capillary tubes, accordingly.

In one embodiment, the microcolumns (or connectors) of the present disclosure can have a length about 0.5 mm, about 1 mm, about 2 mm, about 5 mm, about 10 mm, about 20 mm, about 50 mm, or between any two thereof ranging, e.g., about 0.5-50 mm, about 1-50 mm, about 1-20 mm, about 1-10 mm. The microcolumns (or connectors) of the present disclosure can be easy to connect because a small number of members may be required to form a connecting structure (for example, only a microcolumn and a capillary tube, or only a connector and a capillary tube), and the width for attachment of various members for the connection can be small. In one embodiment, the inner diameter of the portion of the microcolumn (or connector) of the present disclosure that receives a capillary tube can be equal to or about 80% or more, about 90% or more, about 95% or more, about 98% or more, about 99% of the outer diameter of the capillary tube.

The packing material of the present invention can be a particulate packing material or a monolithic packing material. In one embodiment, the microcolumns (or connectors) of the present disclosure contain particulate packing materials. Typically, microcolumns may also include a porous member to retain the particulate packing material in the microcolumn. Particulate packing materials are generally preferred because higher binding capacities can be achieved compared to monolithic packing materials.

In another embodiment, the microcolumn (or connector) of the present disclosure comprises a monolithic packing. A monolithic packing is preferable, as no porous member may be required to retain the packing material in the microcolumn.

In one embodiment, the column tube of the present disclosure has an outer diameter of about 0.1 mm, about 0.2 mm, about 0.5 mm, about 1 mm, about 2 mm, about 5 mm, about 10 mm, or any range between any two thereof, for example, in the range about 0.1-10 mm, about 0.5-10 mm, about 0.5-5 mm. If no additional members are attached around the column tube, the outer diameter of the column tube can be the outer diameter of the connection structure, so the connection structure of the present disclosure can be formed in a very small space and allows for highly flexible piping. In one embodiment, the column tubes of the present disclosure can have an inner diameter of about 0.1 mm, about 0.2 mm, about 0.5 mm, about 1 mm, about 2 mm, about 5 mm, or any range between any two thereof, for example, it a range about 0.05-5 mm, about 0.1-5 mm, about 0.2-2 mm.

In one embodiment, the column tube of the present disclosure comprises an opening that directly receives a capillary tube. This opening can be an opening positioned outwardly in the micro-column. In one embodiment, the opening of the column tube may be adjusted to have an inner diameter equal to or greater than the outer diameter of the capillary tube to facilitate insertion of the capillary tube. For example, the opening of the column tube may be flared. In one embodiment, the inner diameter of the column tube (the portion that receives the capillary tube) can be equal to or smaller than the outer diameter of the capillary tube: about 70% or more, about 80% or greater, about 90% or greater, about 95% or greater, about 98% or greater, about 99% or greater of the outer diameter of the capillary tube. In one aspect, when the microcolumn includes a tubular member, the column tube can be a means for adjusting the outer diameter of the capillary tube such that the tubular member can receive the capillary tube.

In one embodiment, the column tube of the present disclosure is made of fluororesin (for example, polytetrafluoroethylene (PTFE), perfluoroalkoxyalkane (PFA), fluorinated ethylene propylene (FEP), ethylenetetrafluoroethylene (ETFE), TEFLO N®, TEFZEL®, DELRIN®), polyetheretherketone (PEEK), polyetherimide (PEI), polyphenylene sulfide (PPS), polypropylene, sulfone polymers, polyolefins, polyimides, polyaryletherketone, and polyoxymethylene (POM). Preferably, the column tube of the present disclosure is composed of a flexible and rigid fluororesin such as TEFLON®, and is liquid-tight when receiving a capillary tube.

In one embodiment, the length of the packed bed of the packing material in the column tube (or inner column tube) is about 0.5 mm, about 1 mm, about 2 mm, about 5 mm, about 10 mm, about 20 mm, about 50 mm, or any range between two of these, for example, about 0.5-50 mm, about 1-50 mm, about 1-20 mm, about 1-10 mm. In one embodiment, the packing material can be packed about 3% or more, about 5% or more, about 10% or more, about 20% or more, about 40% or more, about 60% or more, or about 80% of the length of the microcolumn. Since the volume of the packing material that can be retained increases according to the length of the column tube, it may be advantageous to configure the column tube to be somewhat long in order to improve separation performance, for example. It may be important to adjust this length to a pressure range that maintains a liquid-tight connection structure, because the longer the distance over which the flow exists, the more pressure the flow will need to pass through.

The packing material can be a particulate packing material, a monolithic packing material, etc., a packing material structure of a column used in an HPLC system or the like. Due to the short length of the microcolumns of the present disclosure, they can be loaded with particulate packing materials and still operate at low pressures, and additional connecting members may not be required when connecting the microcolumns and capillary tubes. The packing material can be that of the columns used in affinity chromatography, ion exchange chromatography, reverse phase chromatography, normal phase chromatography, etc., and can implement similar modes of separation. Combinations of a target molecule/an affinity ligand in affinity chromatography include biotin-binding proteins such as avidin and streptavidin/biotin, maltose-binding proteins/maltose, G proteins/guanine nucleotides, oligohistidine peptides/nickel or cobalt, and other metal ions, glutathione-S-transferase/glutathione, DNA-binding protein/DNA, antibody/antigen molecule (epitope), antigen molecule (epitope)/antibody, antibody/protein A, antibody/protein G, antibody/protein L, lectin/sugar, calmodulin/calmodulin-binding peptide, ATP-binding protein/ATP, or estradiol receptor protein/estradiol.

In one embodiment, the porous member is positioned inside the column tube (or inner column tube) and in contact with both ends of the packing material. Attachment of the porous member can suppress migration, leakage and/or deformation of the bed of the packing material. In one embodiment, the porous member is no more than about 50%, no more than about 40%, no more than about 20%, no more than about 10%, no more than about 8%, no more than about 6%, no more than about 4%, no more than about 2%, or no more than 1% of the length of the microcolumn. In one embodiment, the porous member can be a porous material (which can also be called a frit), a capillary tube segment (which can also be called an end piece), or both. When the porous member comprises a porous material and a capillary tube segment, the porous material can be placed in contact with the packing material. In one embodiment, the porous member is not fixed to the column tube (or inner column tube) and exists in a state that can be moved by pressing (including insertion of a capillary tube).

In one embodiment, the porous material includes a fibrous material (cotton, asbestos, quartz fiber, etc.), but is not particularly limited as long as it is a material through which a liquid can pass. Since overcompression of the porous material can lead to an increase in the backpressure of the microcolumn, it is preferable to avoid compression by the capillary tube, such as by positioning means (unit). In one embodiment, the capillary tube segment has the same outer diameter and inner diameter as the capillary tube connecting to the microcolumn, but may have a different outer diameter and inner diameter. In embodiments where the capillary tube segment is in direct contact with the packing material, the inner diameter of the capillary tube segment and the structure and size of the packing material are selected such that the packing material does not cause clogging of the capillary tube segment.

In one embodiment, the capillary tube comprises positioning means defining a position to be received in the microcolumn. If the capillary tube is inserted too deeply into the microcolumn, the capillary tube will push the porous member, the packing material and/or the inner column tube, displacing these members within the microcolumn, and causing excessive compression of the porous member, the packing material and/or the inner column tube. On the other hand, if the insertion is too shallow, a dead volume is created between the porous member and the end of the capillary, causing a substantial reduction in column performance. To avoid these problems, positioning means are preferably provided. In one embodiment, the positioning means is a flange-like stopper attached to the capillary tube [for example, a short segment (for example, about 1 mm) of a tubular structure having an inner diameter capable of receiving the capillary tube], or an indicator provided on the capillary tube (e.g., a line, recess, or protrusion on the capillary surface).

In one embodiment, an inner column tube is positioned inside the column tube. In one embodiment, the inner column tube can be made of glass, but the material is not particularly limited. In one embodiment, the inner column tube contains packing material. Since the inner column tube can be protected by the column tube, no remarkable strength is required. The inner diameter of the inner column tube can be about 95%, about 90%, about 80, about 70%, about 60%, and about 50%, and so on, of the inner diameter of the column tube. In one embodiment, the inner diameter of the column tube can be substantially the same as the outer diameter of the inner column tube (with a difference, e.g., about 10% or less, about 5% or less, about 2% or less, about 1% or less).

In one embodiment, the microcolumn (or connector) of the present disclosure comprises a tubular member outside the column tube. In this embodiment, since it is fixed by the tubular member, the column tube may be composed of a plurality of tubes, for example, three tubes, a tube at both ends and a central tube. In one embodiment, the central tube comprises a filler and is configured to increase the inner diameter of the central tube. In one embodiment, a perforated member is positioned within and/or against the central tube. Since packing material may be contained inside the central tube, the central tube may be filled to improve the adsorption/separation performance of the packing material and/or to reduce the pressure increase required for flow due to the presence of packing material. It may be preferable to increase the inner diameter of the tube. Thus, in one embodiment, the internal diameter of the central tube can be configured to be larger than the internal diameter of the end tubes of the column tube and/or the capillary tube. In this embodiment, a capillary tube may be inserted inside the central tube. Therefore, in one embodiment, the capillary tubes are provided with positioning means (described above) that define where they are received in the column tubes, and are configured such that the capillary tubes do not reach the central tube, so that The pore member and filler can be prevented from being pushed by the capillary tube.

In one embodiment, the tubular member of the present disclosure is the same length as the microcolumn (or connector) of the present disclosure. In one embodiment, at least part of the column tube may protrude from the end of the tubular member. In one embodiment, the inner diameter of the tubular member (in undeformed state, if it is deformable) is approximately equal to the outer diameter of the column tube (e.g., the difference of about 10% or less, about 5% or less, about 2% or less, and about 1% or less). In one embodiment, the outer diameter of the tubular members of the present disclosure can be about 0.1 mm, about 0.2 mm, about 0.5 mm, about 1 mm, about 2 mm, about 5 mm, about 10 mm, or ranges between any two thereof, such as, about 0.1-10 mm, about 0.5-10 mm, about 0.5-5 mm. If no additional members are attached around the tubular member, the outer diameter of the tubular member can be the outer diameter of the connection structure, so the connection structure of the present disclosure can be formed in very little space and allows for highly flexible piping. In one embodiment, the tubular member of the present disclosure has a diameter of about 0.05 mm, about 0.1 mm, about 0.2 mm, about 0.5 mm, about 1 mm, about 2 mm, about 5 mm, or a range between any two thereof, for example, it can have an inner diameter of: about 0.05-5 mm, about 0.1-5 mm, and about 0.2-2 mm.

In one embodiment, the tubular member of the present disclosure can be a heat shrinkable material. Heat-shrinkable materials that can be used include, but are not limited to, polyethylene, vinyl acetate polymer, ethylene/methacrylate copolymer, polypropylene, and the like, and any known heat-shrinkable material. As a heat-shrinkable material that can be used, for example, when a rod-shaped molded product with a diameter of 1 mm is heated at 150° C. for 10 minutes, it shrinks to about 90% or less, about 80% or less, or about 70% or less. In one embodiment, tubular members of the present disclosure can be a flexible material. Flexible materials that can be used include, but are not limited to, silicone materials, fluororubbers, urethane rubbers, butadiene rubbers, natural rubbers, elastomers, and any known flexible materials. A flexible material that can be used may have a characteristics at 25° C., for example, about 0.02 kgf/mm², about 0.05 kgf/mm², about 0.1 kgf/mm², about 0.2 kgf/mm², about 0.4 kgf/mm², about 0.6 kgf/mm², about 0.8 kgf/mm², about 1 kgf/mm², or a range between any two thereof, e.g., about 0.02-1 kgf/mm², about 0.05-0.6 kgf/mm², about 0.1-0.4 kgf/mm². As a flexible material, when a square molded product with a thickness of 1 mm and a side of 1 cm is immersed in solvents, for example, acetonitrile, ethyl acetate, ethanol, methanol, and water, for 100 hours at 50° C., the material showing the increment of the volume of about 20% or less, about 10% or less, or about 5% or less, can be preferable.

In one embodiment, the microcolumn (or connector) of the present disclosure further comprises force-applying means (unit) for applying an external force to the tubular member (for example, around the tubular member), and the force applied by the force-applying means deforms the tubular member and causes the space between the central tube and the tubular member to expand or contract. For example, expansion or contraction of the space between the central tube and tubular member can be accompanied by deformation in a direction perpendicular to the axial direction of the micro-column. In this embodiment, a porous member is positioned within at least the central tube. The external force applied by the force-applying means may be a mechanical tensile force, a force utilizing a pressure difference generated between the inside and the outside of the tubular member through pressure operation around the tubular member, or the like. For example, the force-applying means may include a member attached to the tubular member to mechanically pull the tubular member, a member attached around the tubular member so as to create an airtight space around the tubular member, and a member (such as a cylinder or a pump connected in communication with the pressure-regulating space) that increases or decreases the air pressure in the pressure-regulating space may be provided. In this embodiment, the tubular member may be a flexible material as described above, such as a silicone material. By changing the volume of the space between the central tube and the tubular member, a new flow path can be formed between the central tube and the tubular member while maintaining the liquid-tight state, thereby expanding the possibility of controlling the speed and direction of flow inside and outside the central tube and inside the capillary tubes.

When the space between the central tube and the tubular member is inflated, a gap is created between the tubular member and the central tube, and since there is no packing material present in this gap, the flow resistance is low and the flow can be preferential through this gap. For example, in a system in which a solid-phase extraction column (central tube) placed on the anodic side is directly connected to isoelectric focusing separation, the solid-phase extraction column is immersed in an acidic anolyte. When a voltage is applied to both ends, an electroosmotic flow is generated in the column in the direction to the anode, causing the problem that the separation liquid including a sample is drawn out from the capillary for isoelectric focusing toward the anodic direction. After eluting the protein from the solid-phase extraction column, if a gap is generated outside the column tube before voltage is applied, the liquid flow by electroosmosis will return to the outside of the column by the flow control described above, and the isoelectric focusing capillary on the downstream side can be made to have no flow. In this embodiment, it is preferable that channels are formed at the boundary between the central tube and the two end tubes, so that the length of the central tube can be made shorter than the distance between the two end tubes, or by providing grooves (for example, radial grooves directed from the center to the periphery) in the end faces of the end tubes facing the central tube, flow paths can be formed between the inside and the outside of the central tube. Also, when the space between the central tube and the tubular member is contracted, the gap between the tubular member and the central tube disappears, the channel outside the central tube is closed. You can use this state because it can be switched. In one preferred embodiment, sulfonic acid groups can be attached on the outer wall of the central tube to direct electroosmotic flow towards the cathode under acidic conditions.

In one embodiment, the force-applying means comprises a pressure-control member, the pressure-control member being a tubular member covering at least the central tube such that a pressure-regulating space is formed between the pressure-control member and the tubular member. The pressure-control member expands the space between the central tube and the tubular member by reducing the pressure in the pressure-regulating space, and contracts the space between the central tube and the tubular member by pressurizing the pressure-regulating space. In particular, the central portion of the tubular member that covers the central tube may be made of a flexible material.

In one embodiment, the microcolumn (or connector) of the present disclosure does not comprise an additional member around the tubular member (e.g., a member that presses the tubular member from the outside). In another embodiment, the microcolumn (or connector) of the present disclosure may comprise an additional member (for example, a member that presses the tubular member from the outside) around the tubular member, thereby improving liquid tightness. In this embodiment, the tubular member can be the heat shrinkable material described above. In one embodiment, the tubular member can be configured (by heat shrinking) to partially cover the end of the column tube, which can improve the pressure capacity of the microcolumn. For example, such a structure can be formed by inserting various members into a long tubular member, heat shrinking the tubular member, and then cutting the tubular member away from the end of the column tube.

For ease of understanding, but not by way of limitation, specific embodiments of the present disclosure are described below with reference to the drawings.

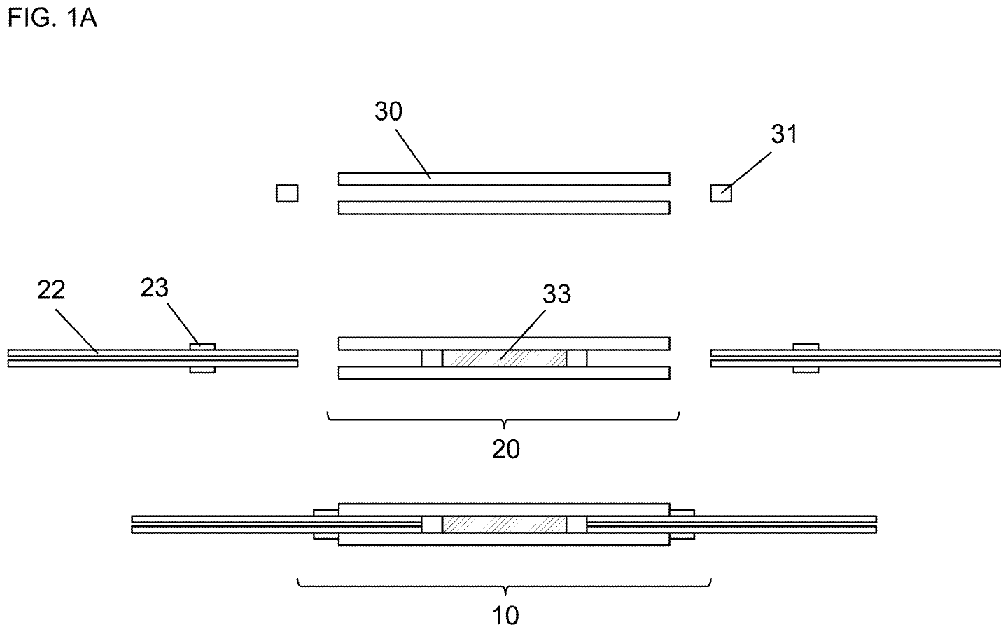

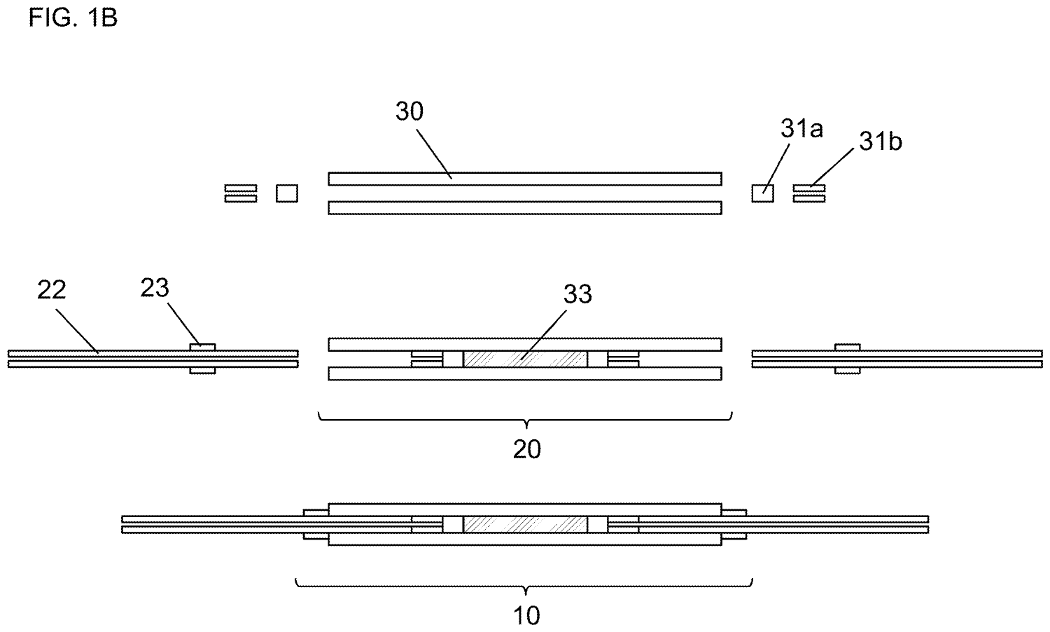

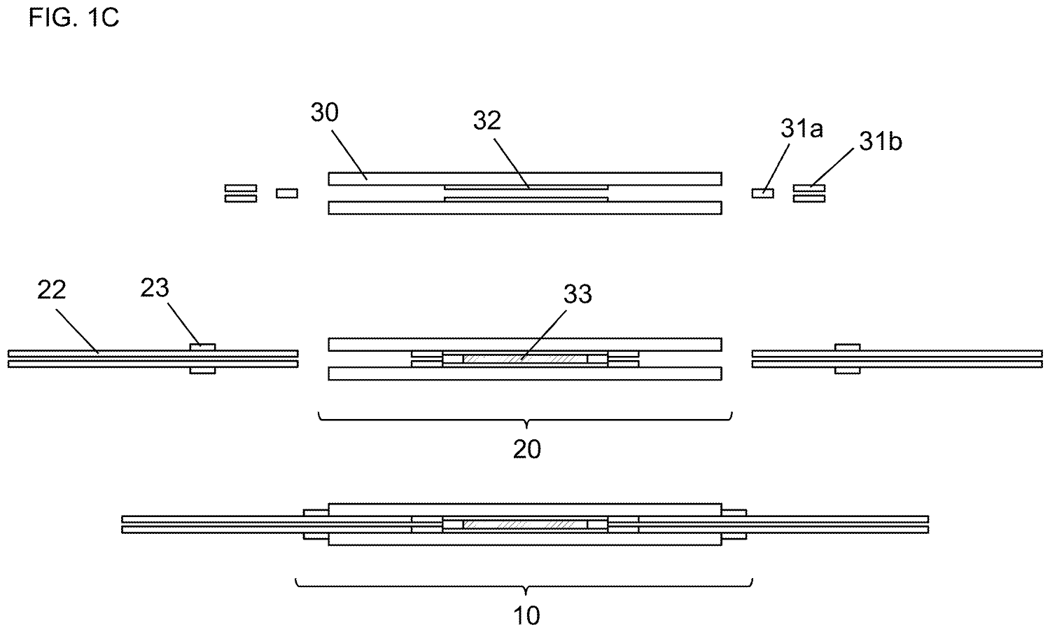

In FIGS. 1A-1C, column tube 30 is filled with packing material 33, porous member 31 is inserted to form microcolumn 20, and then capillary tube 22 is inserted to form connecting structure 10. Column tube 30 corresponds to the connector. Due to the presence of the positioning means 23, the capillary tube 22 does not thrust the porous member 31, and the packing material 33 is protected. In FIG. 1A, the column tube 30 consists of a single tube. In FIG. 1B, the porous member includes porous material 31a and capillary tube segment 31b. In FIG. 1C, the inner column tube is inserted into the column tube, the packing material and porous material 31a are placed inside the inner column tube, and the capillary tube segment 31b is placed outside the inner column tube.

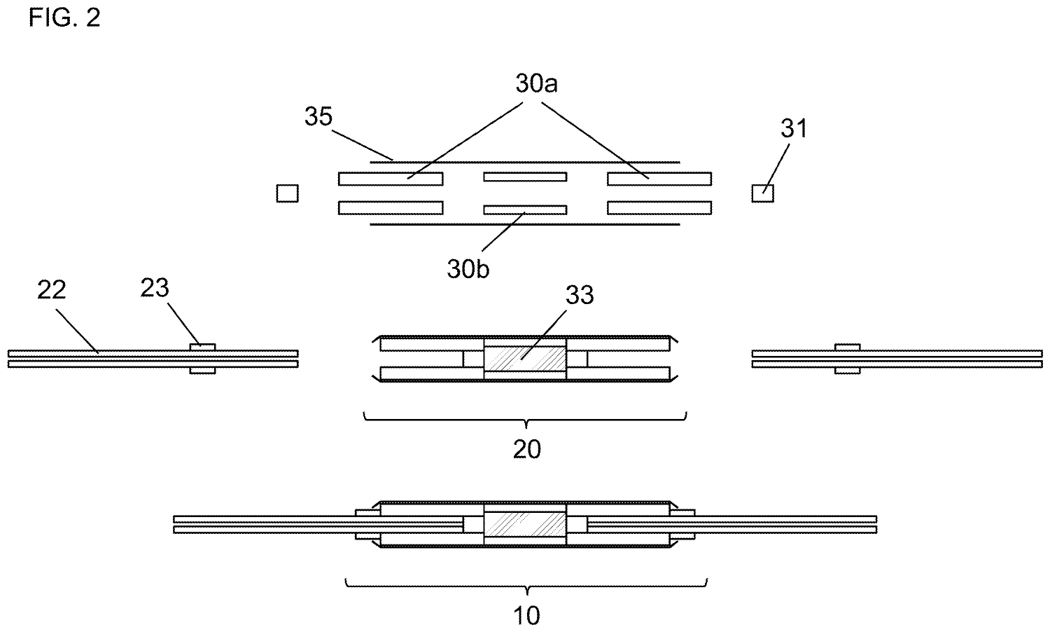

In FIG. 2, the column tube 30 (two end tubes 30a and central tube 30b) is inserted into the tubular member 35 (heat-shrinkable material), the central tube 30b is filled with a packing material 33, and both end tubes 30a are fitted with the porous members 31, and the micro-column 20 is formed by applying heat to shrink the tubular member 35 and then inserting the capillary tube 22 with the positioning means 23 to form the connecting structure 10. The tubular member 35 and the tubes 30a at both ends constitute a connector. Due to the presence of the positioning means 23, the capillary tube 22 does not thrust the porous member 31 and the packing material 33 is protected. Due to the heat shrinkage of the tubular member 35, the tubular member 35 partially covers the ends of the tubes 30a at both ends.

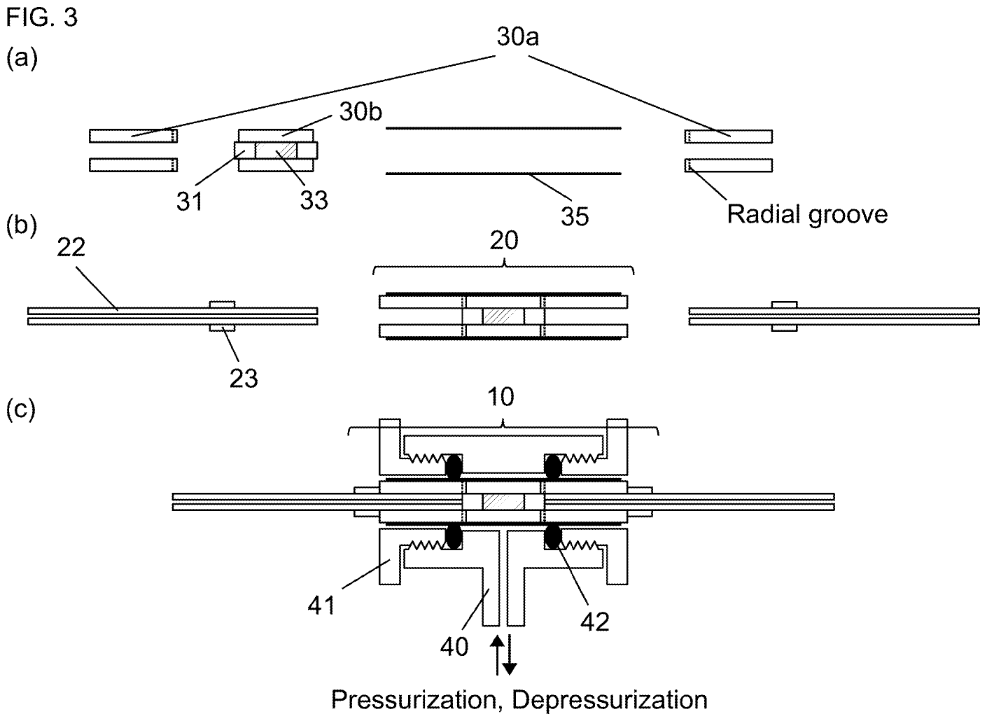

In FIG. 3, the tubular member 35 (flexible material) is first inserted with the end tubes 30a and the central tube 30b (including the packing material 33 and the porous member 31) to form the microcolumn 20. (a). After that, the connection structure 10 is formed by inserting the capillary tube 22 provided with the positioning means 23 (b). Next, a pressure-control member 40, an O-ring 42 and a push screw 41 are attached around the tubular member 35 to form a microcolumn 20 equipped with pressure-control means (c). The tubular member 35 and the tubes 30a at both ends constitute a connector. Due to the presence of the positioning means 23, the capillary tube 22 does not penetrate inside the central tube 30b and does not force the porous member 31. The pressure-control member 40, the O-ring 42 and the push screw 41 constitute a force-application means. A pressure control space is formed between the pressure-control member 40 and the tubular member 35, and the volume around the central tube 30b is increased or decreased by deforming the tubular member 35 made of a flexible material by controlling the pressure. Channels are formed between the central tube 30b and the two end tubes 30a by radial grooves provided at the ends of these tubes.

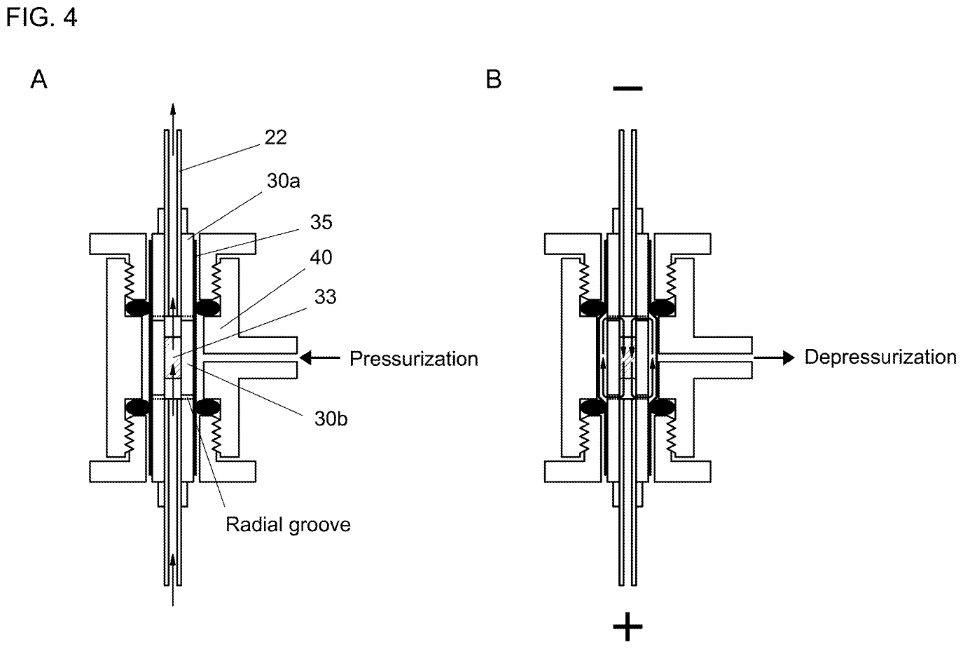

Further reference is made to FIG. 4 for the pressure-controlled behavior of the microcolumn of FIG. 3. Here, it is assumed that a capillary tube for isoelectric focusing is connected downstream of the microcolumn (upper part of the figure). (A) In a state where the pressure-control space is pressurized, only a flow path passing through the central tube 30b is formed near the central tube 30b. A target substance (such as protein) can be trapped in the packing material 33 in the central tube 30b by irrigating a sample solution with a pump or the like. (B) When the pressure-control space is depressurized, the tubular member 35 covering the central tube 30b expands, creating a gap between the tubular member 35 and the central tube 30b. A new flow path is formed together with the gap and the radial grooves provided on the end faces of the two end tubes 30a. After irrigating the anolyte in the central tube 30b, the pressure is reduced at the start of electrophoresis, and voltage is applied in this state. The electroosmotic flow generated in the central tube towards the anodic side flows out through the grooves to the outside of the central tube 30b and back through the grooves at the cathodic side into the central tube 30b. In this way, the effect of electroosmotic flow on the capillary for isoelectric focusing at the cathodic side can be eliminated. To further facilitate this situation, it may be a desirable option to attach sulfonic acid groups to the outer wall of central tube 30b to generate cathodic electroosmotic flow under acidic conditions.

(Manufacturing Method)

In one aspect, the present disclosure provides a manufacturing method of the microcolumn (or connector) of the present disclosure. In one embodiment, this production method may include a step of filling the inside of the column tube with a packing material. In one embodiment, the step of filling the inside of the column tube with the packing material comprises inserting an inner column tube filled with the packing material into the column tube or filling the inside of the inner column tube with the packing material. In one embodiment, the manufacturing method can include inserting the porous member into the column tube and contacting the packing material. In one embodiment, the step of inserting the porous member into the column tube and contacting the packing material may comprise inserting an internal column tube containing the packing material and the porous member into the column tube or inserting a porous member into an internal column tube. In one embodiment, the manufacturing method can include inserting an inner column tube into the column tube. For example, packing of a packing material is performed by first inserting one of the two porous members into the column tube (or inner column tube) and then injecting a solution containing the packing material into the column tube (or inner column tube) by pressing and finally inserting another porous member into the column tube (or inner column tube). When manufacturing the microcolumn (or connector) of the present disclosure, the inner/outer diameters of the column tube, capillary tube, inner column tube, tubular member, etc. are appropriately selected so as to be entirely liquid-tight. Since the inner/outer diameters of tubular structures can change slightly due to heat or pressure, It may be preferable that the tubular structures are subjected to heat or pressure during the manufacture of the microcolumns (or connectors) of the present disclosure. For example, when inserting the column tube into the tubular member, when inserting the inner column tube into the column tube, the insertion can be facilitated by widening the opening of the tubular member or the column tube and/or by heating the tubular member or the column tube. In one embodiment, when manufacturing the microcolumn (or connector) of the present disclosure using a column tube made of a heat-shrinkable material, the method for manufacturing the microcolumn (or connector) may include the step of heating the column tube. The temperature of heating may be, for example, about 100° C., about 150° C., about 200° C., about 300° C., about 400° C., about 500° C., or a range between any two thereof, such as about 100° C. to 500° C., but can be appropriately set by those skilled in the art depending on the type of heat-shrinkable material.

(Application)

The microcolumn (or connector) of the present disclosure can be used by connecting it to a capillary tube used for capillary electrophoresis, LC-MS, and the like. The microcolumn (or connector) of the present disclosure can be easily connected to a capillary tube because it does not require pressing means such as screws. Since the microcolumn of the present disclosure can contain an adsorbent and/or a separating agent as a packing material, it can separate or isolate a specific substance, and can be suitably used in combination with various analytical means. Since it is not necessary to use a pressing means such as a clamp when connecting to the capillary tube, the connection can be facilitated. In one embodiment, the microcolumns of the present disclosure can be used under comparatively low-pressure conditions.

(Note)

In this specification, “or” (“matawa” in Japanese) is used when “at least one or more” of the items listed in the sentence can be adopted. The same applies to “or” (“moshikuwa” in Japanese). When we describe “within a range” of “two values” in this specification, the range includes the two values themselves.

The present disclosure will now be described based on the examples, and the foregoing description and the following examples are provided for illustrative purposes only, and not for the purpose of limiting the present invention. Accordingly, the scope of the present invention is not limited to the embodiments or examples specifically described herein, but only by the claims.

### EXAMPLE

### Example 1: Microcolumn Using Particulate Packing

A microcolumn shown in the schematic diagram of FIGS. 1A-1C was produced according to the following procedure.

1.1 Packing of Particulate Packing A cotton plug (1 mm in length) was inserted as a porous member at a position about 8 mm from one end of a Teflon (registered trademark) column tube (inner a diameter: 0.35 mm, outer diameter: 1.5 mm, length: 30 mm). Then, a capillary tube (inner diameter: 0.05 mm, outer diameter: 0.36 mm), which was connected to a negative pressure generator, was inserted 10 mm into the same end of the column tube. As the capillary was inserted, the cotton plug moved inside the column tube while being in contact with the end of the capillary. While operating the negative pressure generator at atmospheric pressure minus 0.5 atm, the other end of the column tube was immersed in a suspension of agarose gel particles (average particle size 0.034 mm) under a microscope, and a predetermined amount of gel particles was applied to the column. Aspirated gel particles deposited in front of the cotton plug. The pressure of the negative pressure generator was set to atmospheric pressure, and another cotton plug was inserted until it touched the trailing edge of the aspirated and deposited gel particles. The column tube was cut at a position 10 mm from the end of the cotton plug not in contact with the gel particles.

1.2 Affinity Chromatography Using a Microcolumn

Agarose gel particles immobilized with protein G as an affinity ligand were placed in a Teflon (registered trademark) column tube (inner diameter: 0.35 mm, outer diameter: 1.5 mm, length: 26 mm) in the same manner as above. The length of the column bed was 4 mm, and cotton plugs with a length of 1 mm were used as the porous member. The distance between the porous member and the end of the column tube was 10 mm. As a capillary tube connected to the column, a fused silica capillary (with a polyimide coating) having an inner diameter of 0.05 mm and an outer diameter of 0.36 mm (Molex LLC, USA) was used. As a stopper, a PEEK tube (Upchurch Scientific Inc., USA) with an inner diameter of 0.4 mm, an outer diameter of 1.5 mm, and a length of 1 mm was adhered to the outside of the capillary tube connected to the microcolumn at a position 10 mm from the end of the capillary to optimize the depth of insertion when pushing the capillary tube into the column. The length of the inlet-side capillary tube was 80 mm and the length of the outlet-side capillary tube was 340 mm. At the exit capillary, the polyamide coating is removed at a position 220 mm from the microcolumn, and a fluorescence detector is placed here to detect fluorescence (excitation light 280 nm, detection light 340 nm) derived from tryptophan residues of proteins in the capillary. In addition, a non-contact electrical conductivity detector was placed at a position 180 mm from the microcolumn to detect changes in electrical conductivity. When a physiological phosphate buffer solution (PBS, pH 7.3) was sent at atmospheric pressure +0.5 atm, the flow rate was 1.1 μL/min. On the other hand, the flow rate was 1.3 μL/min without connecting the microcolumn.

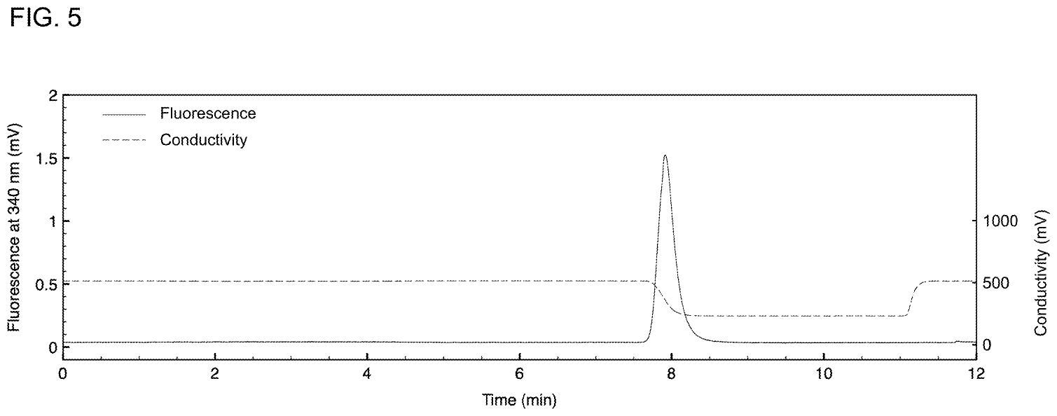

In the following experiments (results are shown in FIG. 5), irrigation of the column was performed at 0.5 atm and room temperature. A solution of the antibody drug cetuximab dissolved in PBS at a concentration of 500 ng/μL was injected into the microcolumn equilibrated with PBS for 3 minutes (0 to 3 minutes, it took about 1 minute for the injected solution to reach the detection point). Next, the column was irrigated with PBS for 3 minutes to wash away substances that did not bind to protein G (3-6 minutes). Then, the column was irrigated with 0.2 M iminodiacetic acid (pH 2.25) for 3 minutes (6 to 9 minutes), and then with PBS for 3 minutes to return the column to neutral conditions (9 to 12 minutes).

Looking at the chromatogram in FIG. 5, almost no protein was detected at the detection points during sample addition (1 to 3 minutes) and during column washing with PBS (3 to 6 minutes). This shows that almost all the added cetuximab was strongly captured in the protein G column (solid line). On the other hand, when an acidic 0.2 M iminodiacetic acid solution was injected (6 to 9 minutes), protein elution was observed. A decrease in electrical conductivity (dotted line) was observed along with the detection of the protein peak. As the electrical conductivity of 0.2 M iminodiacetic acid solution is lower than that of PBS, this indicates that the elution of cetuximab was caused by replacement of PBS in the column with iminodiacetic acid solution.

Thus, the microcolumn of the present disclosure can be easily incorporated into a system and can achieve good separation in a small space. Higher binding capacities can be achieved more easily when using particulate packing than when using monolithic packing, so it may be possible to reduce the size and flow resistance of microcolumns. In addition, since the microcolumn of the present disclosure can achieve separation at an extremely low flow rate, it is suitable for analysis using a mass spectrometer as a detector. In addition, the microcolumn of the present disclosure can also be effectively used for isoelectric focusing variant analysis of a specific protein in a biological sample using direct coupling of solid-phase extraction and capillary isoelectric focusing.

1.3 Direct Coupling of Affinity Chromatography and Capillary Isoelectric Focusing Using the Microcolumn

In the same manner as an Example 1, cetuximab in a sample solution was once adsorbed to the microcolumn filled with the protein G-immobilized agarose gel particles used in Example 1, the buffer components contained in the sample were washed away, and then the acidic anolyte was applied. Cetuximab was eluted from the microcolumn into an isoelectric focusing capillary connected to the outlet side, where it was directly separated and detected by isoelectric focusing. This method is an application of a direct coupling of affinity chromatography and capillary isoelectric focusing (ACCIEF) (U.S. Pat. No. 9,927,399).

The inlet capillary had an inner diameter of 0.05 mm, an outer diameter of 0.36 mm and a length of 80 mm. The outlet capillary also used for isoelectric focusing had an inner diameter of 0.05 mm, an outer diameter of 0.36 mm, and a length of 340 mm. The outer wall of each capillary was coated with polyimide, and the inner wall was coated with a hydrophilic polymer. However, for scanning detection of the separated sample, the polyimide coating of the outlet capillary had been removed through a range of 135-35 mm from the end not connected to the microcolumn. It was set in a scanning-detection capillary isoelectric focusing apparatus (ACE BioAnalysis Inc.) with the inlet side capillary facing the anode. Protein detection was performed with fluorescence at 340 nm (excitation at 280 nm), and scanning detection was performed over a range of 120 mm to 40 mm, i.e., 80 mm for 80 s, in the direction from the anodic side at a speed of 1 mm/s. The electrical conductivity detector was set at a position 185 mm from the end.

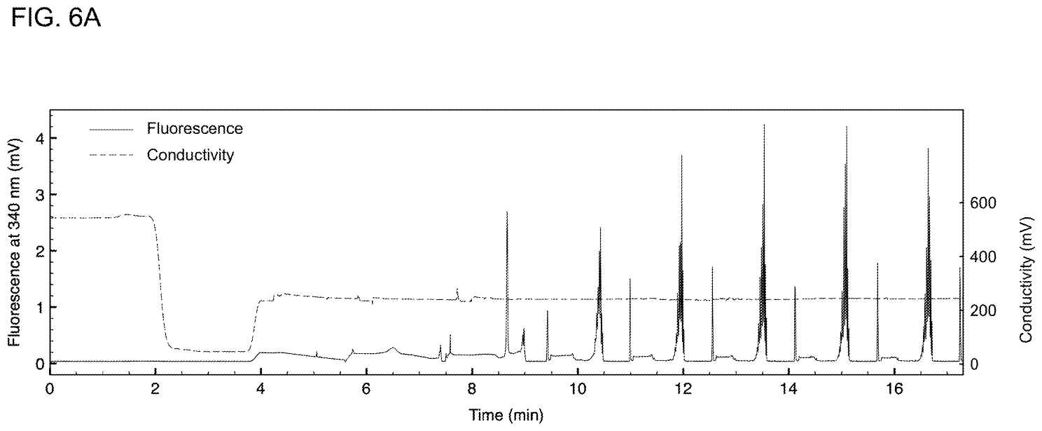

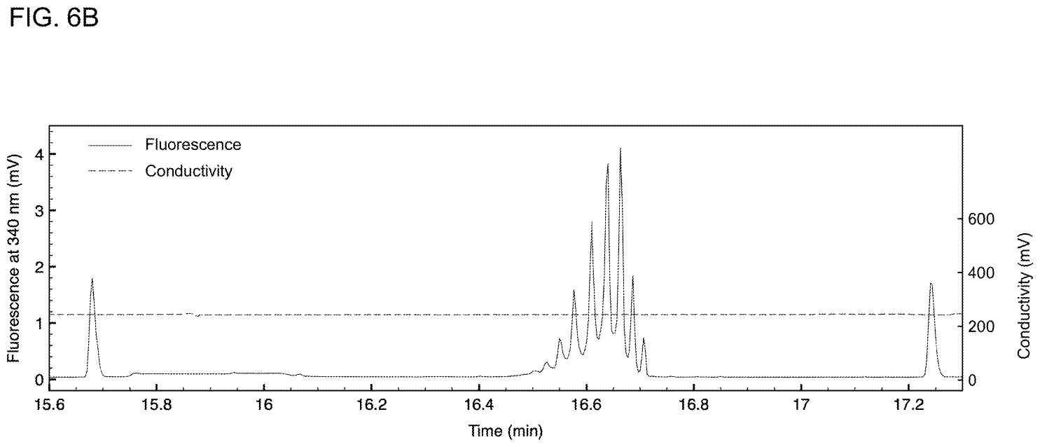

The following liquid transfer was performed at a pressure of 40 kPa. After equilibrating the microcolumn by running physiological phosphate-buffered saline (PBS) for 3 minutes, a solution containing cetuximab at a concentration of 0.25 μg/μL was injected for 30 seconds (approximately 0.5 μL), followed by PBS for 60 seconds to remove unbound materials form the microcolumn. Looking at the fluorescence trace from 0 to 2 minutes in FIG. 6a, there was no protein elution during this period, and almost all the cetuximab added to the microcolumn was adsorbed. Next, a separation solution containing a carrier ampholyte necessary for forming a pH gradient was allowed to flow for 60 seconds. The decrease in electrical conductivity observed at about 2 minutes indicates the replacement of PBS with the separation solution. A 0.2 M iminodiacetic acid solution (pH 2.25) was then applied until an increase in electrical conductivity was detected (at about 4 minutes). At this point, an increase in fluorescence was observed, indicating that the elution of Cetuximab had occurred. The inlet end was immersed in 0.2 M iminodiacetic acid solution as the anolyte, and the outlet end was immersed in 1 M NaOH as the catholyte. One cycle of scanning was done with application of 5 kV, another single cycle of scanning was done with 7 kV, and 6 cycles of scanning was done with 10 kV (FIG. 6A). The 6th scanning detection result is enlarged and shown in FIG. 6B. Cetuximab captured by the microcolumn was separated from the buffer components and the like in the sample, and then separated into isoelectric point variants (pI variants) by isoelectric focusing and detected. The peaks visible at both ends of this figure are the fluorescence signals of the sample detected when the scanning detection unit returns to the starting point at ten times the speed of scanning detection.

As described above, by using the microcolumn of the present invention for ACCIEF analysis, a trace sample is concentrated in the microcolumn, and after removing unnecessary interfering components, all of them are separated by capillary isoelectric focusing to reveal the distribution pattern of isoelectric point variants of a protein.

### Example 2: Microcolumn Equipped with a Tubular Member for Microseparation

A microcolumn similar to that shown in the schematic diagram of FIG. 2 was produced according to the following procedure. Although the following is an example of a microcolumn using a monolithic packing material, a microcolumn using a particulate packing material can also be produced by a similar procedure.

2.1 Production of Glycol-Monolith Packed Column Tube (0.8 mm Inner Diameter)

A glycol monolith was formed in a glass capillary tube (Fuji Rika Kogyo Co., Ltd., Osaka City) with an outer diameter of 1.6 mm and an inner diameter of 0.8 mm. Cut the above capillary tube containing glycol monolith into a length of about 3 mm, polish both ends with grit 400 waterproof sandpaper until the length is 2.0 mm, and use the glycol monolith packed column tube as the central tube of the column tube. was completed.

2.2 Fabrication of Microcolumn and Connection Structure

A Teflon (registered trademark) tube with an outer diameter of 1.6 mm and an inner diameter of 0.35 mm was cut to a length of 9.5 mm as end tubes of the column tube, and a heated needle was inserted into one of the openings to widen the opening like a trumpet. Into a heat-shrinkable tube (Sumitube A, Sumitomo Electric Industries, Ltd., Osaka) with an inner diameter of 2.1 mm, a wall thickness of 0.2 mm, and a length of 30 mm, one of the end tubes, the central tube containing the monolith, and another end tube were inserted in this order. At this time, the end tubes were arranged so that the opening widened like a trumpet faces the outside. The three parts were placed in close contact in a heat-shrinkable tube, and the whole was placed in an air stream at 100° C. for about 30 seconds to shrink the tube. After allowing to cool, both ends of the heat-shrinkable tube were cut so as to be about 0.5 mm longer than the end tubes at both ends to complete a microcolumn. The connecting structure was completed by connecting 0.36 mm OD fused silica capillary tubes (with polyimide coating) (Molex LLC, USA) with stoppers fixed 10 mm from the ends to both sides of the microcolumn. The stopper was attached by passing a capillary tube through a PEEK tube (Upchurch Scientific Inc., USA) with an outer diameter of 1.6 mm and an inner diameter of 0.4 mm (Upchurch Scientific Inc., USA) cut to a length of 1 mm and fixing it with an instant adhesive.

The structure of the microcolumn prepared as in this example can hold a larger amount of packing material than the microcolumn prepared in Example 1. It is thought that a larger amount of analyte can be separated and detected and, therefore, the types of analytes that can be detected in amounts exceeding the detection limit can be increased. In addition, since the inner diameter of the central tube is large, the pressure applied to the microcolumn can be reduced, enabling analysis at a higher flow rate in a shorter time.

### Example 3: Microcolumn with a Flow Adjustment Function

A microcolumn similar to that shown in the schematic diagram of FIG. 3 was produced according to the following procedure. However, although the following is an example of a microcolumn using a monolithic packing material, a microcolumn using a particulate packing material can also be produced by the same procedure.

3.1 Production of Glycol Monolith-Packed Column Tube

As Example 2, a glycol monolith-packed column tube (outer diameter: 1.6 mm, inner diameter: 0.8 mm, length: 2.0 mm) was produced as the central tube of the column tube.

3.2 Fabrication of Microcolumn and Connection Structure

As end tubes of the column tube, Teflon (registered trademark) tubes with an outer diameter of 1.6 mm and an inner diameter of 0.35 mm were cut to a length of 10 mm, and one opening was widened like a trumpet by putting a hoot needle to the opening. On the other end face, eight grooves with a depth of about 0.1 mm extending radially from the center were made. One of the two end tubes, the central tube, and another end tube was inserted in this order into a silicone tube (Nagayanagi Kogyo Co., Ltd., Tokyo; an outer diameter of 2 mm, an inner diameter of 1.5 mm, and a length of 22 mm) working as the tubular member to form a microcolumn. At this time, the end tubes were placed with the trumpet-shaped openings facing outward, and the three were tightly attached within the silicone tube. A fused-silica capillary tube (outer diameter 0.36 mm, inner diameter 0.15 mm, the inner wall and outer wall of which is coated with a hydrophilic polymer and a polyimide, respectively) with a stopper at 10 mm from the end was connected to the column tube, and on the other end of the column tube, a fused-capillary tube for isoelectric focusing (outer diameter 0.36 mm, inner diameter 0.05 mm, length 340 mm, inner wall coated with a hydrophilic polymer, outer wall coated with a polyimide) with a similar stopper was connected. A pressure-control member (made by PMMA) (Miyamoto Resin Industry Co., Ltd., Fukushima City) with an inner diameter of 2.7 mm at the center was equipped with O-rings (NSA3 standard, wire diameter 1.5 mm, inner diameter 2.5 mm, outer diameter 5.5 mm) and push screws (Miyamoto Jushi Kogyo Co., Ltd., Fukushima City), and the microcolumn was inserted into the pressure-control member. The pish screws were tightened to fix the column, and the capillary tubes for inlet and for isoelectric focusing were connected to complete the microcolumn or the connection structure.

The small size of the microcolumns allows fine tuning of the flow, addressing the problem of electroosmotic flow produced in the microcolumn that compromise the separation occurring in the capillaries for isoelectric focusing in downstream.

(Note)

Although the present disclosure has been illustrated using the preferred embodiments thereof, it is understood that the present invention is to be construed in scope only by the claims. It is understood that the patents, patent applications and other publications cited herein are hereby incorporated by reference in their entireties to the same extent as if the contents themselves were specifically set forth herein.

### INDUSTRIAL APPLICABILITY

The present disclosure provides novel microcolumns, which can be used in analytical techniques using capillary tubes, such as capillary electrophoresis and LC-MS.

### DESCRIPTION OF SYMBOLS

10: Connection structure
20: Microcolumn
22: Capillary tube
23: Positioning means (Positioning unit)
30: Column tube
30a: End tubes of a column tube
30b: Central tube of a column tube
31: Porous member
31a: Porous materials
31b: Capillary tube segment
32: Inner column tube
33: Packing material
35: Tubular member
40: Pressure-control member
41: Push screw
42: O-ring

1. A microcolumn for use in a connection structure, said connection structure comprising said microcolumn and two capillary tubes, said microcolumn comprising a column tube and a packing material packed inside said column tube and porous members disposed within said column tube in contact with both ends of said packing material, said microcolumn comprising openings at both ends thereof for receiving said capillary tubes.

2. The microcolumn of claim 1, wherein the porous member comprises a porous material.

3. The microcolumn of claim 1, wherein said porous member comprises a fibrous material.

4. The microcolumn of claim 1, wherein the porous member comprises a capillary tube segment.

5. The microcolumn of claim 1, wherein the porous member comprises a porous material and a capillary tube segment, wherein the porous material being placed in contact with the packing material.

6. The microcolumn according to claim 1, wherein the inner diameter of the column tube is substantially the same as the outer diameter of the capillary tube.

7. The microcolumn according to claim 1, wherein the packing material is a particulate packing material.

8. The microcolumn according to claim 1, wherein the column tube is made of a fluororesin material.

9. The microcolumn according to claim 1, comprising a positioning unit that defines a position where the capillary tube is received in the column tube.

10. The microcolumn of claim 9, wherein said positioning unit defines a position such that an end of said capillary tube contacts the end of said porous member.

11. The microcolumn according to claim 1, wherein the column tube includes an inner column tube, the inner diameter of the column tube is substantially the same as the outer diameter of the inner column tube, and the inner column tube contains the packing material therein.

12. The microcolumn of claim 11, wherein the inner column tube contains the porous member therein.

13. The microcolumn of claim 11, wherein the porous member is positioned in contact with the inner column tube.

14. The microcolumn according to claim 1, wherein the column tube is composed of a single tube.

15. The microcolumn according to claim 11, wherein said column tube is composed of a plurality of tubes, said plurality of tubes being connected via said inner column tube.

16. The microcolumn according to claim 1, further comprising a tubular member covering the column tube.

17. The microcolumn of claim 16, wherein said column tube is composed of three tubes including a central tube and end tubes, said central tube containing said packing material.

18. The microcolumn of claim 17, wherein the inner diameter of the central tube is greater than the inner diameter of the end tubes.

19. The microcolumn of claim 17, wherein said end tubes comprise said porous member.

20. The microcolumn according to claim 16, wherein the tubular member is made of a heat-shrinkable material.

21. The microcolumn of claim 16, wherein the tubular member partially covers the end of the column tube.

22. The microcolumn according to claim 17, further comprising a force-applying unit that applies an external force to the tubular member, wherein the tubular member being deformed by the application of the external force by the force-applying unit, thereby expanding or shrinking the space between the central tube and the tubular member.

23. The microcolumn according to claim 17, wherein the force-applying unit comprises a pressure-control member, and the pressure-control member is arranged around at least a portion of the tubular member covering the central tube such that a pressure-regulating space is formed between the pressure-control member and the tubular member.

24. The microcolumn according to claim 23, wherein the pressure-control member expands the space between the central tube and the tubular member by reducing the pressure in the pressure-regulating space, and shrinks the space between the central tube and the tubular member by pressurizing the pressure-regulating space.

25. The microcolumn according to claim 22, wherein said central tube comprises said porous member.

26. The microcolumn according to claim 22, wherein at least a portion of the tubular member covering the central tube is made of a flexible material.

27. A micro-column kit comprising:
the microcolumn according to claim 1;
said capillary tube;
and a positioning unit that defines a position where said capillary tube is received in said micro-column.

28. The microcolumn kit according to claim 27, wherein said positioning unit is a stopper attached to said capillary tube or an indicator provided on said capillary tube.

29. A method for measuring a sample, comprising:
connecting the microcolumn according to claim 1 to a capillary tube to form a connection structure;
flowing a sample through the connecting structure;
and measuring the sample that has passed through the connecting structure.

30. The method according to claim 29, which is a measurement method by capillary electrophoresis, LC-MS, or capillary electrophoresis-MS.

31. The method for manufacturing a microcolumn according to claim 1, comprising:
packing the inside of the column tube with the packing material;
and inserting the porous member into the column tube being in contact with the packing material.
